(19) United States
(12) Patent Application Publication
(10) Pub. No.: US 2022/0269785 A1
(43) Pub. Date: Aug. 25, 2022

(54) ENHANCED CYBERSECURITY ANALYSIS FOR MALICIOUS FILES DETECTED AT THE ENDPOINT LEVEL

(71) Applicant: Saudi Arabian Oil Company, Dhahran (SA)

(72) Inventors: Reem Abdullah Algarawi, Al Jubail (SA); Majed Ali Hakami, Dhahran (SA)

(73) Assignee: Saudi Arabian Oil Company, Dhahran (SA)

(21) Appl. No.: 17/182,888

(22) Filed: Feb. 23, 2021

(51) Int. Cl. G06F 21/56; G06F 21/53

(52) U.S. Cl. CPC G06F 21/565; G06F 21/53; G06F 21/566; G06F 2221/034

(57) ABSTRACT

Embodiments herein relate to identifying, by an electronic device based on a signature that identifies a file, a first parameter of the file. The electronic device can further identify, based on a behavior of the file that is to occur if the file is executed, a second parameter of the file. The electronic device can further identify a first value based on the first parameter and a second value based on the second parameter. The electronic device can further identify, based on the first value and the second value, a probability that the file is malware. The electronic device can further output an indication of the probability. Other embodiments may be described or claimed.

### TECHNICAL FIELD

The present disclosure applies to malicious file detection at a network endpoint.

### BACKGROUND

Legacy techniques for malware detection at the endpoint level may be inherently prone to false-positive reporting. These false positives may result in unnecessary use of time or resources by forensic teams to validate or invalidate the reported false-positives.

### SUMMARY

The present disclosure describes techniques that can be used to enhance the process of identifying false-positives and true-negatives based on a scoring mechanism related to the file under analysis. More specifically, techniques include an endpoint with a signature-based detection engine in conjunction with a behavior-based engine that analyze the file to determine the probability that the file is or is related to malware.

In embodiments, the file that is under analysis can be scanned and then analyzed through the signature-based detection engine. Then, the network endpoint can use the results of the signature-based analysis as a weighted indicator to identify whether to perform the behavior-based analysis by the behavior-based engine, which can then yield a second weighted indicator. Then, both the first and second indicators can be used to calculate a final score that can be used by a malware examiner to decide whether to initiate static or code malware analysis.

As used herein, a “false-positive” can refer to an incorrect identification that a file is malware. Similarly, a “true-negative” can refer to a correct identification that the file is not malware. Finally, an “endpoint” or “network endpoint” can refer to a device that is connected to a network and transmits or receives messages to or from a network such as a local area network (LAN) a wide area network (WAN), or some other network. An endpoint can be, for example, a desktop, a laptop, a smartphone, a personal digital assistant (PDA), a tablet, a workstation, etc. “Malware” or a “malicious file” can refer to a file or set of files that attempt to perform an unauthorized modification of one or more components of a network such as altering, encrypting, deleting, adding, etc. one or more files or folders on one or more components of the network.

In some implementations, a computer-implemented method includes: identifying, by an electronic device based on a signature that identifies a file, a first parameter of the file; identifying, by the electronic device based on a behavior of the file that is to occur if the file is executed, a second parameter of the file; identifying, by the electronic device, a first value based on the first parameter and a second value based on the second parameter; identifying, by the electronic device based on the first value and the second value, a probability that the file is malware; and outputting, by the electronic device, an indication of the probability.

The previously described implementation is implementable using a computer-implemented method; a non-transitory, computer-readable medium storing computer-readable instructions to perform the computer-implemented method; and a computer-implemented system including a computer memory interoperably coupled with a hardware processor configured to perform the computer-implemented method/the instructions stored on the non-transitory, computer-readable medium.

The subject matter described in this specification can be implemented in particular implementations, to realize one or more of the following advantages. One such advantage can be the reduction of false-positive identifications due to a more robust detection engine. Another such advantage can be a more thorough file assessment based on performance of the assessment at a network endpoint, thereby distributing the assessment workload.

The details of one or more implementations of the subject matter of this specification are set forth in the Detailed Description, the accompanying drawings, and the claims. Other features, aspects, and advantages of the subject matter will become apparent from the Detailed Description, the claims, and the accompanying drawings.

### DESCRIPTION OF DRAWINGS

FIG. 1 depicts an example network architecture, in accordance with various embodiments.

FIG. 2 depicts an example malware detection architecture, in accordance with various embodiments.

FIG. 3 depicts an example technique for malware detection, in accordance with various embodiments.

FIG. 4 depicts an alternative example technique for malware detection, in accordance with various embodiments.

FIG. 5 depicts a block diagram illustrating an example computer system used to provide computational functionalities associated with described algorithms, methods, functions, processes, flows, and procedures as described in the present disclosure, in accordance with various embodiments.

Like reference numbers and designations in the various drawings indicate like elements.

### DETAILED DESCRIPTION

The following detailed description describes techniques for robust malware detection at a network endpoint based on both a signature-based and behavior-based analysis. Various modifications, alterations, and permutations of the disclosed implementations can be made and will be readily apparent to those of ordinary skill in the art, and the general principles defined can be applied to other implementations and applications, without departing from scope of the disclosure. In some instances, details unnecessary to obtain an understanding of the described subject matter can be omitted so as to not obscure one or more described implementations with unnecessary detail and inasmuch as such details are within the skill of one of ordinary skill in the art. The present disclosure is not intended to be limited to the described or illustrated implementations, but to be accorded the widest scope consistent with the described principles and features.

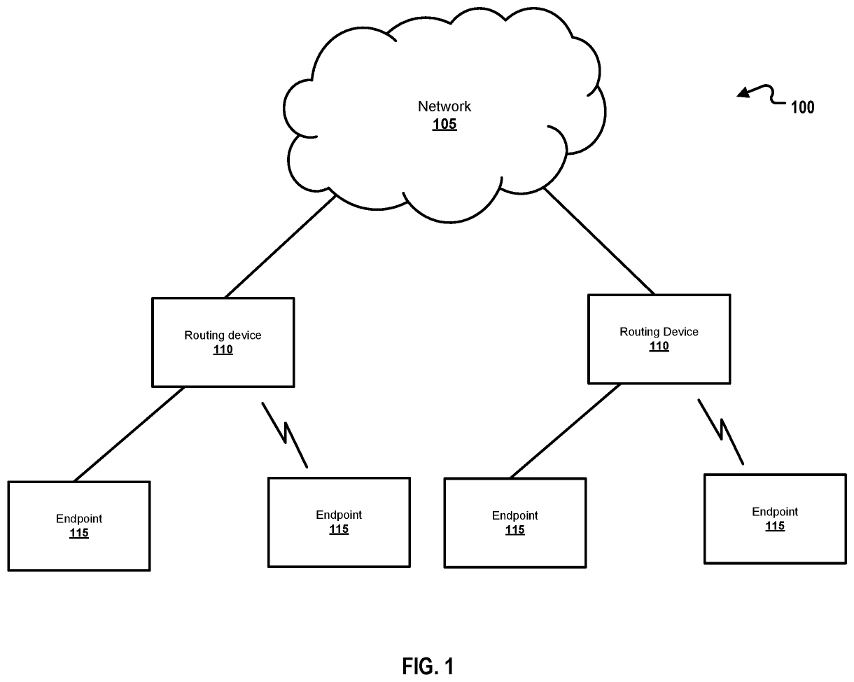

FIG. 1 depicts an example network architecture 100, in accordance with various embodiments. It will be understood that the example network architecture 100 is intended as a highly simplified depiction of such an architecture for the sake of context and discussion of embodiments herein, and real-world examples of such an architecture can include more or fewer elements than are depicted in FIG. 1.

The network architecture 100 can include a number of network endpoints 115. As previously noted, the endpoints 115 can be, include, or be a component of an electronic device such as a user laptop, desktop, workstation, smartphone, PDA, internet of things (IoT) device, etc. More generally, the endpoints 115 can be considered to be an electronic device which is accessible to, and operable by, an authorized user of the network.

The endpoints 115 can be communicatively coupled with one or more routing devices 110. The routing devices 110 can be, include, or be part of an electronic device such as a bridge, a switch, a modem, etc. The communication link between the endpoints 115 and the routing devices can, in some embodiments, be wired links (as indicated by the solid line between the routing devices 110 and the endpoints 115) that operate in accordance with a protocol such as an Ethernet protocol, a universal serial bus (USB) protocol, or some other communication protocol. Additionally or alternatively, the communication link can be a wireless communication link (as indicated by the zig-zag line between the routing devices 110 and the endpoints 115) that operates in accordance with a protocol such as Wi-Fi, Bluetooth, or some other wireless communication protocol. In some embodiments, as shown in FIG. 1, the routing device(s) 110 can be communicatively coupled with endpoint(s) 115 through both a wired and a wireless protocol, while in other embodiments a routing device 110 can be configured to only couple with an endpoint through a wired or a wireless protocol.

The routing devices 110 can be communicatively coupled with one another through a network 105. The network 105 can be or include one or more electronic devices such as a server, a wireless transmit point, etc. The network 105 can further include one or more wired or wireless links through which the various elements of the network 105 are communicatively coupled. In some embodiments, the network architecture 100 can be in a same location (e.g., a same building), while in other embodiments different elements of the network architecture 100 (e.g., the different routing devices 110) can be located in different physical locations.

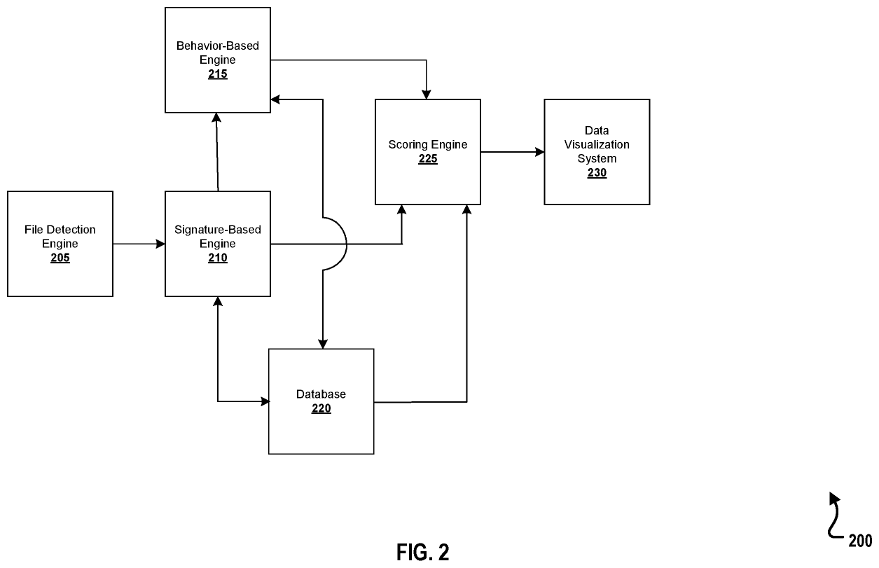

FIG. 2 depicts an example malware detection architecture 200, in accordance with various embodiments. Similarly to FIG. 1, it will be understood that the architecture 200 is intended as a simplified example of such an architecture for the sake of discussion of various embodiments herein. In other embodiments, the architecture can include more or fewer elements than are depicted in FIG. 2. It will also be understood that while the architecture 200 is discussed as being an element of an endpoint such as one of endpoints 115, in other embodiments one or more of the elements of the architecture 200 can be located separately from the endpoint. For example, in some embodiments the database 220 can be located in a memory of an endpoint, while in other embodiments the database 220 can be located separately from the endpoint, but communicatively coupled with the endpoint through one or more wired or wireless links. Additionally, it will be understood that while certain elements or engines of the architecture 200 are depicted as separate from one another, in some embodiments the various engines can be combined, for example as sections of a unitary piece of software, as hardware elements on a single platform such as a system on chip (SoC), or in some other manner.

The architecture 200 can include a file detection engine 205. The file detection engine 205 can be configured to identify a file that is present on the endpoint. For example, in some embodiments the file can have just been introduced to the endpoint (e.g., through transmission via a wired or wireless link, download by a user of the endpoint, connection of a removable media device such as a flash drive or USB drive, or in some other manner). In other embodiments, the file can be identified based on a scheduled or unscheduled analysis of files on the endpoint such as can be performed based on scheduled antivirus software. In some embodiments, the file can be identified by the file detection engine 205 based on one or more preconfigured rules or signatures. For example, the file detection engine 205 can run, or be part of, a whitelisting engine or whitelisting software that is operable to detect a program or application that is not approved for use. In this embodiment, the file detection engine can be configured to detect the file without performing analysis on whether the file is malicious.

The architecture 200 can further include a signature-based engine 210. The signature-based engine 210 can be configured to identify, based on a signature of the file, a first parameter of a file. The signature of the file can be an identifier of the file and can include one or more characteristics such as a name of the file, a hash of the file, a publisher of the file, or some other type of identifier.

In some embodiments, the parameter can be a human-readable word, phrase, or sentence that relates to the malware status of the file. For example, the parameter can be a word like “trojan,” “virus,” “ransomware,” “generic malware,” “suspicious,” “probably unwanted program (PUA),” etc. In some embodiments, the parameter can be identified based on a comparison of the file signature to one or more tables that include data related to the word(s) or phrase(s) and the file signature. Such a table can be stored in a database 220 that, as noted above, can be an element of the endpoint or can be stored in a memory that is communicatively coupled with the endpoint. As such, identification of the parameter can be based on retrieval of the parameter from the database 220 based on the file signature.

In some embodiments, if the signature is not a signature which has been previously analyzed by the signature-based engine 210, then information related to the file or the file signature can be provided to the database 220 by the signature-based engine 210. In some embodiments, this information include providing the database 220 with one or more of the identified file signatures. User input can then be received from the database to further populate the table, for example using one or more of the words or phrases described above.

The architecture 200 can further include a behavior-based engine 215, which can be configured to identify one or more behaviors of the file. For example, the behavior-based engine 215 can be configured to execute the file on a virtual machine to analyze how the file can perform. For example, the behavior-based engine 215 can identify that, during execution of the file on the virtual machine, the file is attempting to gain unauthorized access to another file or folder on the endpoint. In one example of such attempt to gain unauthorized access, the file can attempt to alter (e.g., encrypt) or delete the other file or folder on the endpoint. In another example of such unauthorized access, the file can attempt to install a file or folder on the endpoint without the user's knowledge.

In this situation, the behavior-based engine 215 can identify one or more behavior-related parameters based on the behavior of the file. Similarly to the signature-related parameters, the behavior-related parameters can be or include a human-readable word or phrase such as the name of a particular type of malware (e.g., “WannaCry”). In other embodiments, the human-readable word or phrase can include “keylogger,” “registry modification,” etc.

Similarly to the signature-based engine 210, identification of the parameter can be based on one or more tables that are stored in database 220 wherein identified behaviors of the file under execution are compared to elements of the table(s) to identify the human-readable word or phrase. Additionally, as noted above, in some embodiments the table(s) can not include an entry for the identified behavior, and so modification of the table(s) can be performed as described above.

It will be noted that, although identification of the behavior of the file is described based on execution of the file by a virtual machine, more specifically the behavior-based analysis can be performed inside a system-managed unsupervised virtual machine, which can also be referred to as a “sandbox.” More specifically, the sandbox can perform the analysis without the supervision of a human analyst. Additionally, it will be noted that, in the architecture 200 of FIG. 2, the file is first analyzed by the signature-based engine 210 before being provided to the behavior-based engine 215. This process flow can be desirable because signature-based analysis can be relatively computationally simple, being based on comparison of an identifier of the file to a table such as can be stored in database 220. However, behavior-based analysis can be more computationally-intensive, for example by being based on analysis of the behavior of the file if executed by a virtual machine as described above. Therefore, it can be desirable for the signature-based analysis to be performed first so that files that are identified as being risk-free (for example, based on comparison of the file signature to a known “good” file) are identified and so further computationally-intensive analysis by the behavior-based engine can be avoided. However, in other embodiments the analysis by the behavior-based engine 215 can be performed prior to, or at least partially concurrently with, analysis by the signature-based engine 210.

The parameter(s) identified by the signature-based engine 210 and the behavior-based engine 215 can then be supplied to a scoring engine 225, which can calculate a score value related to the parameter(s). Specifically, the scoring engine 225 can calculate a first numerical value related to the parameter produced by the signature-based engine, and a second numerical value related to the parameter produced by the signature-based engine. The numerical values can be identified based on one or more tables stored in database 220, and can be based on classification of the parameters such as “weak” or “strong.” For example, a “weak” parameter can be one that includes the term “generic,” “riskware,” “probably,” “adware,” “unsafe,” “potentially unwanted program (PUP),” “potentially unwanted application (PUA),” “unwanted,” “extension,” etc. These “weak” parameters can be assigned a value of less than or equal to 50. By contrast, a “strong” parameter can be a parameter that includes the term “ransomware,” “botnet,” “advanced persistent threat (APT),” “exploit,” “backdoor,” “keylogger,” “phishing,” “worm,” “trojan,” “spyware,” etc. These “strong” parameters can be assigned a value of greater than 50. However, it will be understood that these values are provided as examples only and, in other embodiments, the distinction between “strong” and “weak” can be based on some other value threshold. Additionally, in some embodiments, additional distinctions can be made such as “weak,” “moderate,” and “strong.”

The scoring engine 225 can then identified a score value based on at least the first and second numerical values. The score value can be based on addition of the first and second values, an average or mean of the first and second values, or some other combination of the first and second values. In this way, if the score value is based on two “weak” parameters, then the overall score value can be relatively low. However, if one or both of the parameters are “strong” parameters, then the score value can be relatively high.

It will be noted that although only two values are discussed herein (e.g., one value based on the signature-based analysis and another value based on the behavior-based analysis), in other embodiments the score value can be based on additional values. For example, the signature-based analysis can provide two or more parameters, each of which can have a numerical value that is used in the calculation of the score value. Additionally or alternatively, the behavior-based analysis can provide two or more parameters, each of which can have a numerical value that is used in the calculation of the score value. In some embodiments where the signature-based (or behavior-based) analysis provides a plurality of parameters, a single numerical value can be identified for the signature-based (or behavior-based) analysis based on some combination or function of numerical values related to the various parameters.

The score value can then be compared against a pre-identified threshold value to identify a probability that the file is malware. In some embodiments, this comparison can additionally or alternatively include comparison of one or both of the first and second numerical values to one or more threshold values. In some embodiments, the probability can take the form of a numerical value, while in other embodiments the probability can additionally or alternatively take the form of a human-readable word or phrase such as “likely,” “unlikely,” etc.

The result of the scoring engine can then be provided to data visualization system 230. For example, one or more of the first value, the second value, the first parameter, the second parameter, the score value, etc. can be provided to a data visualization system 230 which is configured to output an indication of one or more of the provided elements. In some embodiments, the data visualization system 230 can output the one or more provided elements in a dashboard, which can include additional context or elements, color-coding, an indication of a suggested remedial action, etc. Through use of the dashboard, a user of the system (e.g., an information technology (IT) or security professional) can be able to identify whether the file is malicious (e.g., malware) and perform a remedial action such as deleting the file, running antivirus software, etc.

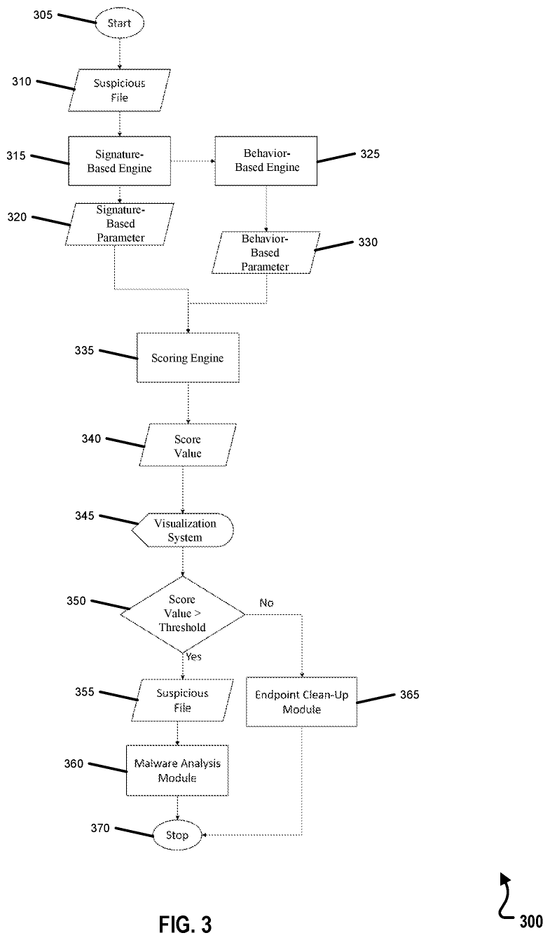

FIG. 3 depicts an example technique 300 for malware detection, in accordance with various embodiments. Generally, the technique 300 can be executed, in whole or in part, by the architecture 200 described above. It will be understood that the technique 300 is intended as an example technique for the sake of discussion of concepts and embodiments herein, and other embodiments can include more or fewer elements than those depicted in FIG. 3. In some embodiments, certain of the elements depicted in FIG. 3 can be performed in an order different than that depicted in FIG. 3 (for example, the order of certain elements can be switched, or some elements can be performed concurrently with one another). In some embodiments, the technique 300, or at least elements 305-345, can be performed by a single electronic device, while in other embodiments the technique 300, or at least elements 305-345, can be performed by a plurality of electronic devices.

The technique can start at 305. Initially, a suspicious file can be identified at 310, for example by the file detection engine 205 as described above. The suspicious file can be input, at 315, to a signature-based engine that can be similar to the signature-based engine 210. The signature-based engine can identify, at 320, a signature-based parameter that can be similar to the signature-based parameter described above with respect to the signature-based engine 210.

The file can also be provided, by the signature-based engine at 325, to a behavior-based engine that can be similar to, for example, the behavior-based engine 215. The behavior-based engine can be configured to identify, at 330, one or more behavior-based parameters as described above.

The signature-based and behavior-based parameters can be provided, at 335, to a scoring engine that can be similar to, for example, the scoring engine 225. The scoring engine at 335 can be configured to identify, based on the signature-based parameter and the behavior-based parameter, a score value at 340 as described above. For example, the score value identified at 340 can be based on a function applied to a first value related to the signature-based parameter and a second value that is related to the behavior-based parameter. As described above, the function can be based on addition of the values, an average of the values, a mean of the values, or some other function. Additionally, as described above, in some embodiments the score value identified at 340 can be based on a plurality of numerical values for one or both of the behavior-based and signature-based parameter(s). In some embodiments, the scoring engine 225 can further compare the score value against a pre-identified threshold value, as described above with respect to FIG. 2.

One or more of values identified at 335 or 340 can then be provided to a data visualization system 345, which can be similar to the data visualization system 230 of FIG. 2. Specifically, one or more of the score value, the signature-based parameter, the behavior-based parameter, the first value, the second value, etc. can be provided to the data visualization system 345 as described above with respect to FIG. 2. The data visualization system 345 can, in turn, generate a graphical display or some other display (e.g., an audio output or some other output) of one or more of the pieces of the data. For example, the data visualization system 345 can provide an indication in the form of a graphical user interface (GUI), a dashboard, or some other indication of the score value, the parameter(s), the first or second value(s), etc. In some embodiments, a value such as the score value can be color-coded such that it is a different color dependent on whether it is above, below, or equal to the threshold value. In some embodiments, the visualization system can further identify a suggested remedial action that is to be taken with respect to the file, or an electronic device on which the file is located (e.g., running a malware program, deleting one or more infected files or folders, etc.).

Elements 350, 355, 360, and 365 provide example actions that can be taken by a user of the architecture 200 based on the output of the visualization system 345. In this embodiment, the architecture is designed such that a malware file will be identified based on having a score value that is above the threshold value, as indicated at 350. However, it will be understood that in other embodiments the values and weights used can provide a score value for a malware file that is greater than or equal to the threshold value, less than the threshold value, or less than or equal to the threshold value. That is, the same signature and behavior-based analysis can be performed but the weighting can be different in other embodiments.

At 350, the user of the architecture 200 can identify, based on the output of the visualization system at 345, whether the score value is above the threshold value. If the score value is greater than the threshold value, then the file under analysis can be identified as a suspicious file at 355, which means that it is likely malware. That is, both of the signature and the behavior engines identified that the file was likely malware and assigned signature-based and behavior-based parameters accordingly. The user can therefore provide the file to a robust malware analysis module at 360 that can be, for example, an antivirus program or some other program wherein the file can be analyzed to identify a remedial action to be taken. The technique 300 can then end at 370.

If the score value is not greater than the threshold value at 350, then the user can run an endpoint clean-up module at 365. The endpoint clean-up module can be, run, or be part of antivirus or other clean-up/removal programs. Specifically, the endpoint clean-up module can be configured to perform some form of clean-up or other remediation on files that are identified as malware, but are labeled as “weak” per the scoring system (e.g., having a score that is not greater than the threshold value at 350). In this situation, it can be desirable to perform the antivirus or other clean-up procedure without further intervention by a human analyst. Subsequent to running the endpoint clean-up module at 365, the technique can end at 370.

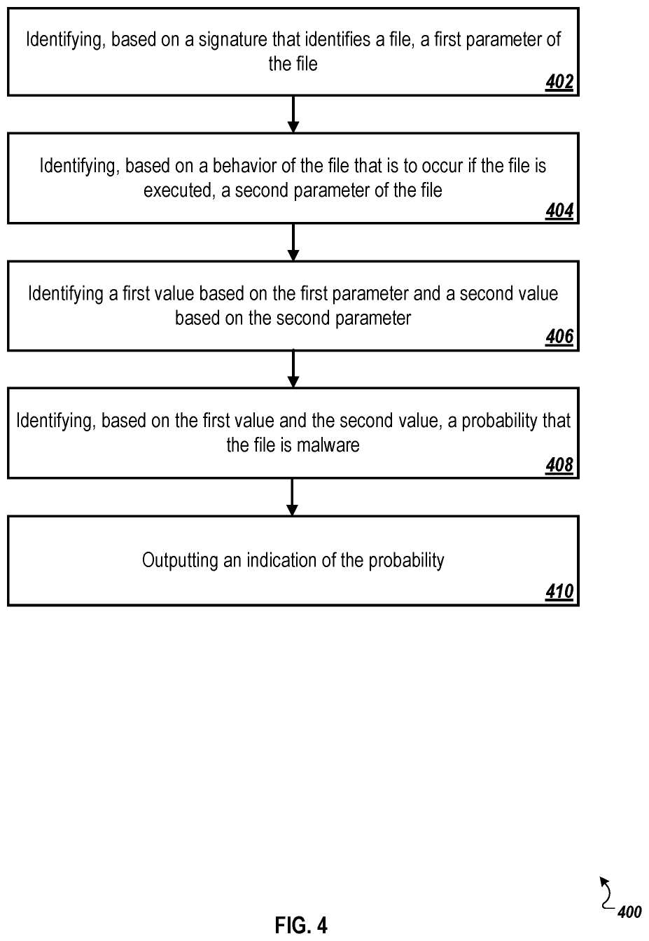

FIG. 4 depicts an alternative example technique 400 for malware detection, in accordance with various embodiments. Similarly to the technique of FIG. 3, it will be understood that the technique 400 of FIG. 4 is intended as an example embodiment of such a technique for the sake of discussion of various concepts herein. In other embodiments, the technique 400 can include more or fewer elements than are depicted in FIG. 4, elements occurring in a different order than depicted, elements occurring concurrently with one another, etc.

The technique 400 can include identifying, at 402 based on a signature that identifies a file, a first parameter of the file. This identification can be the signature-based identification to identify the signature-based parameter as described above with respect to the signature-based engine 210 or elements 315 and 320.

The technique 400 can further include identifying, at 404 based on a behavior of the file that is to occur if the file is executed, a second parameter of the file. This identification can be the behavior-based identification to identify the behavior-based parameter as described above with respect to the behavior-based engine 215 or elements 325 and 330.

The technique 400 can further include identifying, at 406, a first value based on the first parameter and a second value based on the second parameter. This identification can be the identification of the first value or the second value related to the signature-based and behavior-based parameters as described above with respect to scoring engine 225 or elements 335 or 340.

The technique 400 can further include identifying, at 408 based on the first value and the second value, a probability that the file is malware. This identification can be based on an evaluation of a score value that is based on the first and second values, and then a comparison of the score value to a pre-identified threshold value as described above with respect to the scoring engine 225 or elements 335 or 340.

The technique 400 can further include outputting, at 410, an indication of the probability. This outputting can be as is described above with respect to the data visualization systems 230 or 345, above.

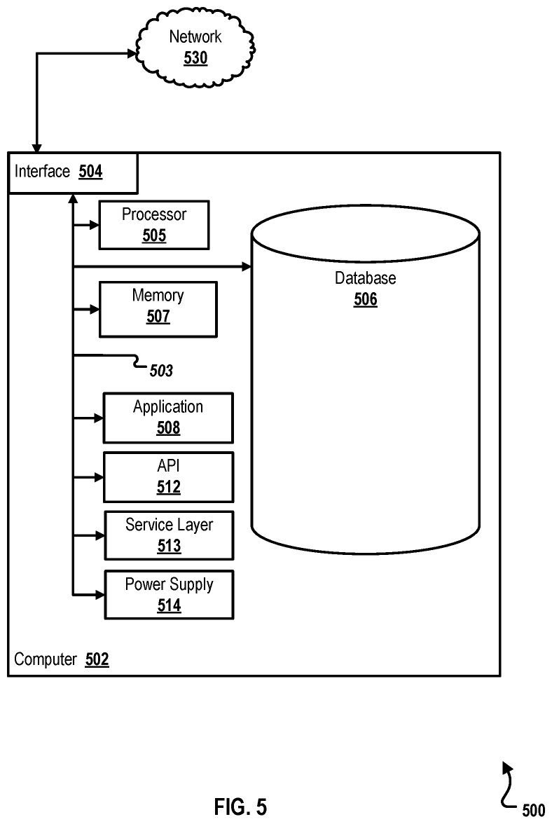

FIG. 5 is a block diagram of an example computer system 500 used to provide computational functionalities associated with described algorithms, methods, functions, processes, flows, and procedures described in the present disclosure, according to some implementations of the present disclosure. In some embodiments, the computer system 500 can be, be part of, or include a network endpoint such as network endpoint 115. Additionally or alternatively, the computer system 500 can be, be part of, or include an architecture such as architecture 200.

The illustrated computer 502 is intended to encompass any computing device such as a server, a desktop computer, a laptop/notebook computer, a wireless data port, a smart phone, a personal data assistant (PDA), a tablet computing device, or one or more processors within these devices, including physical instances, virtual instances, or both. The computer 502 can include input devices such as keypads, keyboards, and touch screens that can accept user information. In addition, the computer 502 can include output devices that can convey information associated with the operation of the computer 502. The information can include digital data, visual data, audio information, or a combination of information. The information can be presented in a GUI.

The computer 502 can serve in a role as a client, a network component, a server, a database, a persistency, or components of a computer system for performing the subject matter described in the present disclosure. The illustrated computer 502 is communicably coupled with a network 530. In some implementations, one or more components of the computer 502 can be configured to operate within different environments, including cloud-computing-based environments, local environments, global environments, and combinations of environments.

At a top level, the computer 502 is an electronic computing device operable to receive, transmit, process, store, and manage data and information associated with the described subject matter. According to some implementations, the computer 502 can also include, or be communicably coupled with, an application server, an email server, a web server, a caching server, a streaming data server, or a combination of servers.

The computer 502 can receive requests over network 530 from a client application (for example, executing on another computer 502). The computer 502 can respond to the received requests by processing the received requests using software applications. Requests can also be sent to the computer 502 from internal users (for example, from a command console), external (or third) parties, automated applications, entities, individuals, systems, and computers.

Each of the components of the computer 502 can communicate using a system bus 503. In some implementations, any or all of the components of the computer 502, including hardware or software components, can interface with each other or the interface 504 (or a combination of both) over the system bus 503. Interfaces can use an application programming interface (API) 512, a service layer 513, or a combination of the API 512 and service layer 513. The API 512 can include specifications for routines, data structures, and object classes. The API 512 can be either computer-language independent or dependent. The API 512 can refer to a complete interface, a single function, or a set of APIs.

The service layer 513 can provide software services to the computer 502 and other components (whether illustrated or not) that are communicably coupled to the computer 502. The functionality of the computer 502 can be accessible for all service consumers using this service layer. Software services, such as those provided by the service layer 513, can provide reusable, defined functionalities through a defined interface. For example, the interface can be software written in JAVA, C++, or a language providing data in extensible markup language (XML) format. While illustrated as an integrated component of the computer 502, in alternative implementations, the API 512 or the service layer 513 can be stand-alone components in relation to other components of the computer 502 and other components communicably coupled to the computer 502. Moreover, any or all parts of the API 512 or the service layer 513 can be implemented as child or sub-modules of another software module, enterprise application, or hardware module without departing from the scope of the present disclosure.

The computer 502 includes an interface 504. Although illustrated as a single interface 504 in FIG. 5, two or more interfaces 504 can be used according to particular needs, desires, or particular implementations of the computer 502 and the described functionality. The interface 504 can be used by the computer 502 for communicating with other systems that are connected to the network 530 (whether illustrated or not) in a distributed environment. Generally, the interface 504 can include, or be implemented using, logic encoded in software or hardware (or a combination of software and hardware) operable to communicate with the network 530. More specifically, the interface 504 can include software supporting one or more communication protocols associated with communications. As such, the network 530 or the interface's hardware can be operable to communicate physical signals within and outside of the illustrated computer 502.

The computer 502 includes a processor 505. Although illustrated as a single processor 505 in FIG. 5, two or more processors 505 can be used according to particular needs, desires, or particular implementations of the computer 502 and the described functionality. Generally, the processor 505 can execute instructions and can manipulate data to perform the operations of the computer 502, including operations using algorithms, methods, functions, processes, flows, and procedures as described in the present disclosure.

The computer 502 also includes a database 506 that can hold data for the computer 502 and other components connected to the network 530 (whether illustrated or not). For example, database 506 can be an in-memory, conventional, or a database storing data consistent with the present disclosure. In some implementations, database 506 can be a combination of two or more different database types (for example, hybrid in-memory and conventional databases) according to particular needs, desires, or particular implementations of the computer 502 and the described functionality. Although illustrated as a single database 506 in FIG. 5, two or more databases (of the same, different, or combination of types) can be used according to particular needs, desires, or particular implementations of the computer 502 and the described functionality. While database 506 is illustrated as an internal component of the computer 502, in alternative implementations, database 506 can be external to the computer 502.

The computer 502 also includes a memory 507 that can hold data for the computer 502 or a combination of components connected to the network 530 (whether illustrated or not). Memory 507 can store any data consistent with the present disclosure. In some implementations, memory 507 can be a combination of two or more different types of memory (for example, a combination of semiconductor and magnetic storage) according to particular needs, desires, or particular implementations of the computer 502 and the described functionality. Although illustrated as a single memory 507 in FIG. 5, two or more memories 507 (of the same, different, or combination of types) can be used according to particular needs, desires, or particular implementations of the computer 502 and the described functionality. While memory 507 is illustrated as an internal component of the computer 502, in alternative implementations, memory 507 can be external to the computer 502.

The application 508 can be an algorithmic software engine providing functionality according to particular needs, desires, or particular implementations of the computer 502 and the described functionality. For example, application 508 can serve as one or more components, modules, or applications. Further, although illustrated as a single application 508, the application 508 can be implemented as multiple applications 508 on the computer 502. In addition, although illustrated as internal to the computer 502, in alternative implementations, the application 508 can be external to the computer 502.

The computer 502 can also include a power supply 514. The power supply 514 can include a rechargeable or non-rechargeable battery that can be configured to be either user- or non-user-replaceable . In some implementations, the power supply 514 can include power-conversion and management circuits, including recharging, standby, and power management functionalities. In some implementations, the power supply 514 can include a power plug to allow the computer 502 to be plugged into a wall socket or a power source to, for example, power the computer 502 or recharge a rechargeable battery.

There can be any number of computers 502 associated with, or external to, a computer system containing computer 502, with each computer 502 communicating over network 530. Further, the terms “client,” “user,” and other appropriate terminology can be used interchangeably, as appropriate, without departing from the scope of the present disclosure. Moreover, the present disclosure contemplates that many users can use one computer 502 and one user can use multiple computers 502.

Described implementations of the subject matter can include one or more features, alone or in combination. For example, in a first implementation, a network endpoint includes: one or more processors; and one or more non-transitory computer-readable media comprising instructions that, upon execution by the one or more processors, are to cause the network endpoint to: identify, based on a signature that identifies a file, a first parameter of the file; identify, based on a behavior of the file that occurs if the file is executed, a second parameter of the file; identify a first value based on the first parameter and a second value based on the second parameter; identify, based on the first value and the second value, a probability that the file is malware; and output an indication of the probability.

The foregoing and other described implementations can each, optionally, include one or more of the following features:

A first feature, combinable with any of the following features, wherein the instructions to identify the probability that the file is malware include instructions to compare a score value to a threshold value, wherein the score value is based on the first value and the second value.

A second feature, combinable with any of the previous or following features, wherein the signature of the file is a name of a file, an identifier of a publisher of the file, or a hash of the file.

A third feature, combinable with any of the previous or following features, wherein the instructions to identify the second parameter of the file include instructions to simulate execution of the file to identify the behavior of the file.

A fourth feature, combinable with any of the previous or following features, wherein the instructions to simulate execution of the file include instructions to execute the file on a virtual machine in a sandbox environment.

A fifth feature, combinable with any of the previous or following features, wherein the behavior includes an attempted unauthorized alteration of another file based on the simulated execution of the file.

A sixth feature, combinable with any of the previous or following features, wherein the first parameter is a signature-related type of the file.

A seventh feature, combinable with any of the previous or following features, wherein the second parameter is a behavior-related type of the file.

An eighth feature, combinable with any of the previous or following features, wherein the instructions to output the indication of the probability includes instructions to facilitate output of a graphical indication of the probability on a display device that is communicatively coupled with the network endpoint.

In a second implementation, a computer-implemented method includes: identifying, by an electronic device based on a signature that identifies a file, a first parameter of the file; identifying, by the electronic device based on a behavior of the file that is to occur if the file is executed, a second parameter of the file; identifying, by the electronic device, a first value based on the first parameter and a second value based on the second parameter; identifying, by the electronic device based on the first value and the second value, a probability that the file is malware; and outputting, by the electronic device, an indication of the probability.

The foregoing and other described implementations can each, optionally, include one or more of the following features:

A first feature, combinable with any of the following features, wherein the method further includes determining whether to perform the identification of the second parameter of the file based on the signature that identifies the file.

A second feature, combinable with any of the previous or following features, wherein the identifying the probability that the file is malware includes comparing, by the electronic device, a score value to a threshold value, wherein the score value is based on the first value and the second value.

A third feature, combinable with any of the previous or following features, wherein the signature of the file is a name of a file, an identifier of a publisher of the file, or a hash of the file.

A fourth feature, combinable with any of the previous or following features, wherein the identifying the second value includes simulating, by a virtual machine running on the electronic device, execution of the file.

A fifth feature, combinable with any of the previous or following features, wherein the behavior includes an attempted unauthorized alteration of another file based on the simulated execution of the file.

A sixth feature, combinable with any of the previous or following features, wherein the first parameter is a signature-related type of the file.

A seventh feature, combinable with any of the previous or following features, wherein the second parameter is a behavior-related type of the file.

In a third implementation, one or more non-transitory computer-readable media include instructions that, upon execution by one or more processors of a network endpoint, are to cause the network endpoint to: identify, based on a signature of a file that is an identifier of the file or a source of the file, a first parameter of the file; identify, based on a behavior of the file that is to occur if the file was executed, a second parameter of the file; identify a first value based on the first parameter and a second value based on the second parameter; identify, based on the first value and the second value, a probability that the file is malware; and output an indication of the probability.

The foregoing and other described implementations can each, optionally, include one or more of the following features:

A first feature, combinable with any of the following features, wherein the instructions are further to determine whether to identify the second parameter of the file based on the signature of the file.

A second feature, combinable with any of the previous or following features, wherein the instructions to identify the probability that the file is malware include instructions to compare a score value against a threshold value, wherein the score value is based on the first value and the second value.

A third feature, combinable with any of the previous or following features, wherein the signature of the file is a name of a file, an identifier of a publisher of the file, or a hash of the file.

A fourth feature, combinable with any of the previous or following features, wherein the instructions to identify the second parameter of the file include instructions to simulate execution of the file to identify the behavior of the file.

A fifth feature, combinable with any of the previous or following features, wherein the first parameter is a signature-related type of the file.

A sixth feature, combinable with any of the previous or following features, wherein the second parameter is a behavior-related type of the file.

A seventh feature, combinable with any of the previous or following features, wherein the instructions to output the indication of the probability includes instructions to facilitate output of a graphical indication of the probability on a display device that is communicatively coupled with the network endpoint.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. For example, the signal can be a machine-generated electrical, optical, or electromagnetic signal that is generated to encode information for transmission to a suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatuses, devices, and machines for processing data, including by way of example, a programmable processor, a computer, or multiple processors or computers. The apparatus can also include special purpose logic circuitry including, for example, a central processing unit (CPU), a field-programmable gate array (FPGA), or an application-specific integrated circuit (ASIC). In some implementations, the data processing apparatus or special purpose logic circuitry (or a combination of the data processing apparatus or special purpose logic circuitry) can be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, such as LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub-programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory.

Graphics processing units (GPUs) can also be used in combination with CPUs. The GPUs can provide specialized processing that occurs in parallel to processing performed by CPUs. The specialized processing can include artificial intelligence (AI) applications and processing, for example. GPUs can be used in GPU clusters or in multi-GPU computing.

A computer can include, or be operatively coupled to, one or more mass storage devices for storing data. In some implementations, a computer can receive data from, and transfer data to, the mass storage devices including, for example, magnetic, magneto-optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a USB flash drive.

Computer-readable media (transitory or non-transitory, as appropriate) suitable for storing computer program instructions and data can include all forms of permanent/non-permanent and volatile/non-volatile memory, media, and memory devices. Computer-readable media can include, for example, semiconductor memory devices such as random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer-readable media can also include, for example, magnetic devices such as tape, cartridges, cassettes, and internal/removable disks. Computer-readable media can also include magneto-optical disks and optical memory devices and technologies including, for example, digital video disc (DVD), CD-ROM, DVD+/−R, DVD-RAM, DVD-ROM, HD-DVD, and BLU-RAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated into, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that the user uses. For example, the computer can send web pages to a web browser on a user's client device in response to requests received from the web browser.

The term “GUI” can be used in the singular or the plural to describe one or more graphical user interfaces and each of the displays of a particular graphical user interface. Therefore, a GUI can represent any graphical user interface, including, but not limited to, a web browser, a touchscreen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server. Moreover, the computing system can include a front-end component, for example, a client computer having one or both of a graphical user interface or a web browser through which a user can interact with the computer. The components of the system can be interconnected by any form or medium of wireline or wireless digital data communication (or a combination of data communication) in a communication network. Examples of communication networks include a LAN, a radio access network (RAN), a metropolitan area network (MAN), a WAN, Worldwide Interoperability for Microwave Access (WIMAX), a wireless local area network (WLAN) (for example, using 802.11 a/b/g/n or 802.20 or a combination of protocols), all or a portion of the Internet, or any other communication system or systems at one or more locations (or a combination of communication networks). The network can communicate with, for example, Internet Protocol (IP) packets, frame relay frames, asynchronous transfer mode (ATM) cells, voice, video, data, or a combination of communication types between network addresses.

The computing system can include clients and servers. A client and server can generally be remote from each other and can typically interact through a communication network. The relationship of client and server can arise by virtue of computer programs running on the respective computers and having a client-server relationship.

Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations. It should be understood that the described program components and systems can generally be integrated together in a single software product or packaged into multiple software products.

Accordingly, the previously described example implementations do not define or constrain the present disclosure. Other changes, substitutions, and alterations are also possible without departing from the spirit and scope of the present disclosure.

Furthermore, any claimed implementation is considered to be applicable to at least a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

What is claimed is:

1. A network endpoint comprising:
one or more processors; and
one or more non-transitory computer-readable media comprising instructions that, upon execution by the one or more processors, are to cause the network endpoint to:
identify, based on a signature that identifies a file, a first parameter of the file;
identify, based on a behavior of the file that occurs if the file is executed, a second parameter of the file;
identify a first value based on the first parameter and a second value based on the second parameter;
identify, based on the first value and the second value, a probability that the file is malware; and
output an indication of the probability.

2. The network endpoint of claim 1, wherein the instructions to identify the probability that the file is malware include instructions to compare a score value to a threshold value, wherein the score value is based on the first value and the second value.

3. The network endpoint of claim 1, wherein the signature of the file is a name of a file, an identifier of a publisher of the file, or a hash of the file.

4. The network endpoint of claim 1, wherein the instructions to identify the second parameter of the file include instructions to simulate execution of the file to identify the behavior of the file.

5. The network endpoint of claim 4, wherein the instructions to simulate execution of the file include instructions to execute the file on a virtual machine in a sandbox environment.

6. The network endpoint of claim 1, wherein the first parameter is a signature-related type of the file.

7. The network endpoint of claim 1, wherein the second parameter is a behavior-related type of the file.

8. The network endpoint of claim 1, wherein the instructions to output the indication of the probability includes instructions to facilitate output of a graphical indication of the probability on a display device that is communicatively coupled with the network endpoint.

9. A method comprising:
identifying, by an electronic device based on a signature that identifies a file, a first parameter of the file;
identifying, by the electronic device based on a behavior of the file that is to occur if the file is executed, a second parameter of the file;
identifying, by the electronic device, a first value based on the first parameter and a second value based on the second parameter;
identifying, by the electronic device based on the first value and the second value, a probability that the file is malware; and
outputting, by the electronic device, an indication of the probability.

10. The method of claim 9, wherein the method further includes determining whether to perform the identification of the second parameter of the file based on the signature that identifies the file.

11. The method of claim 9, wherein the identifying the probability that the file is malware includes comparing, by the electronic device, a score value to a threshold value, wherein the score value is based on the first value and the second value.

12. The method of claim 9, wherein the signature of the file is a name of a file, an identifier of a publisher of the file, or a hash of the file.

13. The method of claim 9, wherein the identifying the second value includes simulating, by a virtual machine running on the electronic device, execution of the file.

14. The method of claim 13, wherein the behavior includes an attempted unauthorized alteration of another file based on the simulated execution of the file.

15. One or more non-transitory computer-readable media comprising instructions that, upon execution by one or more processors of a network endpoint, are to cause the network endpoint to:
identify, based on a signature of a file that is an identifier of the file or a source of the file, a first parameter of the file;
identify, based on a behavior of the file that is to occur if the file was executed, a second parameter of the file;
identify a first value based on the first parameter and a second value based on the second parameter;
identify, based on the first value and the second value, a probability that the file is malware; and
output an indication of the probability.

16. The one or more non-transitory computer-readable media of claim 15, wherein the instructions are further to determine whether to identify the second parameter of the file based on the signature of the file.

17. The one or more non-transitory computer-readable media of claim 15, wherein the instructions to identify the probability that the file is malware include instructions to compare a score value against a threshold value, wherein the score value is based on the first value and the second value.

18. The one or more non-transitory computer-readable media of claim 15, wherein the signature of the file is a name of a file, an identifier of a publisher of the file, or a hash of the file.

19. The one or more non-transitory computer-readable media of claim 15, wherein the instructions to identify the second parameter of the file include instructions to simulate execution of the file to identify the behavior of the file.

20. The one or more non-transitory computer-readable media of claim 15, wherein the instructions to output the indication of the probability includes instructions to facilitate output of a graphical indication of the probability on a display device that is communicatively coupled with the network endpoint.
